(19) United States
(12) Patent Application Publication
(10) Pub. No.: US 2006/0074729 A1
(43) Pub. Date: Apr. 6, 2006

(54) Managed services supply chain integration

(76) Inventors: Thomas P. Capotosto, Austin, TX (US); Thomas Kunz, Austin, TX (US); David Ornelas, Austin, TX (US)

Correspondence Address: HAMILTON & TERRILE, LLP, P.O. BOX 203518, AUSTIN, TX, 78720, US

(21) Appl. No.: 10/957,253

(22) Filed: Oct. 2, 2004

(51) Int. Cl. G06F 9/46

(52) U.S. Cl. 705/8

(57) ABSTRACT

A method for providing managed services which includes synchronizing managed services product fulfillment with a manufacturer supply chain.

### BACKGROUND OF THE INVENTION

1. Field of the Invention

The present invention relates to managed services and more particularly to integrating service delivery with a supply chain.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With the proliferation of information handling systems, especially within large scale information handling system installations, an important issue relates to the service and support of the large scale information handling system installations (i.e., installations in which more than a few information handling systems are supported by a single entity. The entity that services and supports such an installation is often referred to as a managed service provider. Managed services, or life-cycle services, generally include deployment services and asset services. More specifically, managed services include some or all of asset deployment and installation services, asset management services (including, e.g., both asset tracking and asset moving services), asset maintenance services and asset retirement services.

A managed service provider provides a customer with an ability to procure, deploy, support and manage information handling system technologies across the life cycle of the information handling systems. Issues relating to managed services include information management and asset utilization while providing quality service delivery and a favorable customer experience.

Known managed service providers can be generally divided into two categories: internally staffed managed service providers and out-sourced managed service providers. Internally staffed managed service providers generally have a number of employees with the specific job description of providing service to a particular client. Out-sourced managed service providers generally use third party service providers to provide service to a particular client of the service provider.

One issue relating to managed services is how to link system order fulfillment with customer needs. In known managed services systems, linking system order fulfillment is accomplished in a partial manner via manual coordination and manual reconciliation of records.

### SUMMARY OF THE INVENTION

In accordance with the present invention, a managed services system which synchronizes product fulfillment with a services supply chain is set forth. In another aspect of the invention, a managed services system which optimizes resource scheduling, event synchronization and information consolidation within the managed services system is set forth.

The managed services system integrates services delivery with the various value or supply chains such as hardware manufacturing and delivery, sale of third party software and peripherals and financial services (e.g., leasing). The managed services system provides greater value for a customer through efficiencies, economies of scale, leveraged buying power, synchronization of order fulfillment (e.g., automatic coordination of a product order with scheduling of an installation service) consolidated reporting, and consolidated billing. Products provided to the managed services customer are viewed as a service within the managed services system. A managed services system in accordance with the present invention optimizes resource utilization around proper skills match, optimizes scheduling with precise scheduling and reduced timelines, minimizes business disruption for a managed services customer and improves information based tracking and management of events.

In one embodiment, the invention relates to a method for providing managed services which includes synchronizing managed services product fulfillment with a manufacturer supply chain.

In another embodiment, the invention relates to a method for providing managed services which includes synchronizing managed services product fulfillment with a manufacturer supply chain, consolidating information relating to the product fulfillment status within a managed services system, and optimizing production scheduling based upon the synchronizing.

In another embodiment, the invention relates to an apparatus for providing managed services which includes means for synchronizing managed services product fulfillment with a manufacturer supply chain.

In another embodiment, the invention relates to an apparatus for providing managed services which includes means for synchronizing managed services product fulfillment with a manufacturer supply chain, means for consolidating information relating the product fulfillment status within a managed services system, and means for optimizing production scheduling based upon the synchronizing.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIGS. 1A and 1B, generally referred to as FIG. 1, show a block diagram of a managed services environment.

FIG. 2 shows a schematic block diagram of a system for managing services.

FIG. 3 shows a schematic block diagram of the flow of a managed services system which incorporates supply chain integration.

FIG. 4 shows a process map diagram of a high level order flow within the managed services system.

FIG. 5 shows a process map diagram of an ordering scenario using a managed services system.

FIG. 6 shows a process map diagram of a notifications phase using a managed services system.

FIGS. 7A and 7B show a process map diagram of another notifications phase using a managed services system.

FIGS. 8A and 8B show a process map diagram of order identifiers using a managed services system.

FIGS. 9A and 9B show a process map diagram of the operation of a deployment portion of a managed services system.

FIG. 10 shows a process map diagram of the operation of a workflow process within a managed services system.

FIG. 11 shows a schematic block diagram of an information handling system which is used within and serviced via a managed services system.

### DETAILED DESCRIPTION

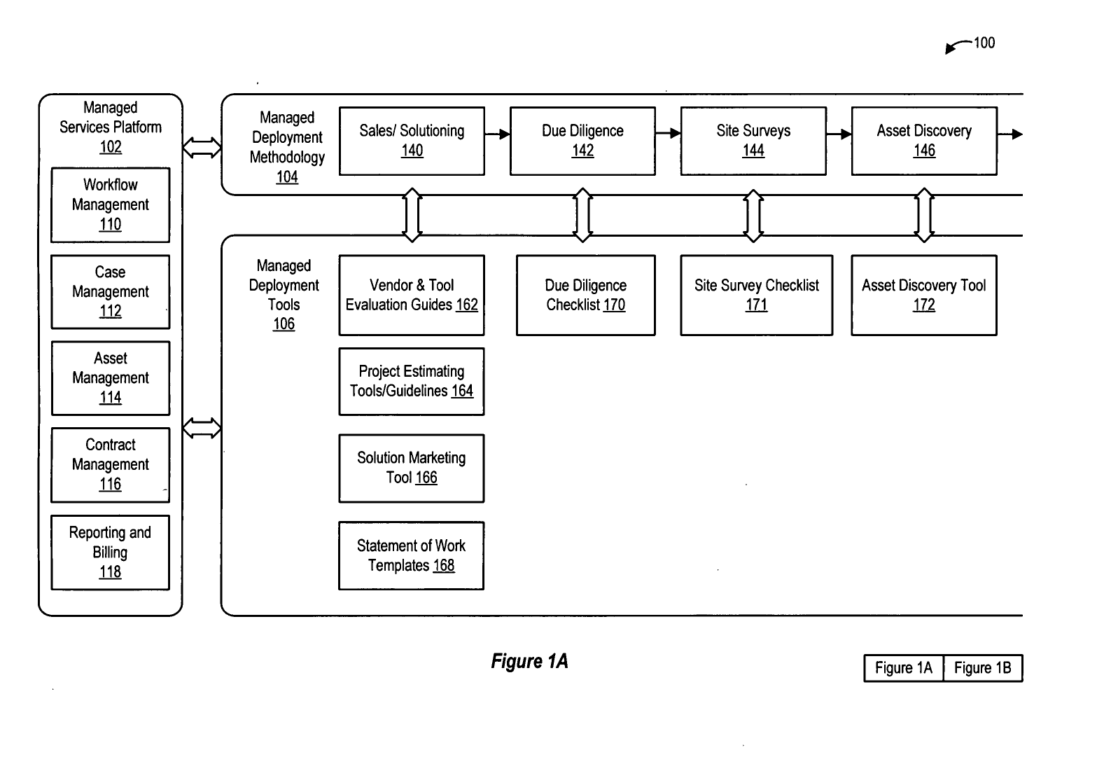

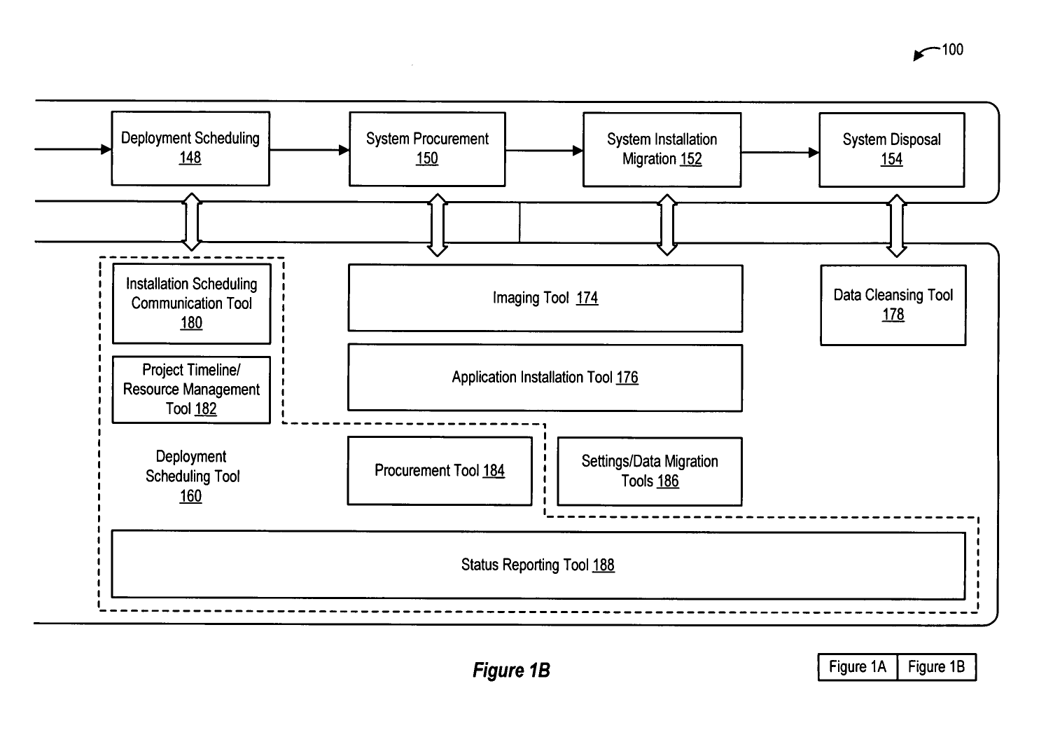

Referring to FIG. 1, a schematic block diagram of a managed services environment 100 is shown. The managed services environment 100 enables: ordering of hardware and managed services together on one order (e.g., via a premier page); the automatic scheduling of time-delayed factory orders, logistics carriers and deployment technicians; the automatic resource planning of managed deployment service partners; the utilization of real time pricing from service partners (or via price auctions); providing the customer the ability to monitor the planning to deployment process; and providing a service partner with visibility of an order to ship process.

The managed services environment 100 includes a managed services platform 102, a managed deployment portion 104 and a managed deployment tools portion 106. The managed services platform 102 provides the core functional modules for providing managed services. The managed deployment tools portion 106 provide accessories that interacting with the core functional modules of the managed deployment platform 102. The managed deployment methodology portion 104 interacts with both the managed deployment platform 102 and the managed deployment tools portion 106 to provide enable a managed services provider to provide managed services.

The managed services platform 102 includes a managed services case management module 112, a managed services workflow management module 110, a managed services asset management module 114, a managed services contract management module 116 and a managed services reporting and billing module 118. The managed services case management module 112 identifies when a service event has occurred or is planned and manages the event as a case that represents a body of billable of work. For example, the service event may be a problem with a computer and the body of billable work may be to fix the computer. Also for example, the service event may be to schedule a move of computers from one building to another building and the body of billable work may be the deployment of technicians to accomplish the move. The workflow management module 110 automates and orchestrates work to accomplish relating to a service event. For example, the workflow management module may automatically identify and schedule required approvals for a particular service event or may perform scheduling and resource management relating to a particular service event. By identifying the steps and roles of a particular service event, the workflow management module 110 enables disaggregating services.

The managed services asset management module 114 provides a clear record around whatever is the subject of the managed service. For example, the record may describe the asset, include a corresponding unique identifier such as a service tag include the financials relating to the asset, identify the owner of the asset, the location of the asses and any licensing constraints relating to the asset. The managed services contract management module 116 identifies the level of service that has been contracted with the customer for an asset. The contract management module 116 provides a repository for the terms and conditions that bind the commitment around delivering the service to a customer.

The managed services reporting and billing module 118 supports reporting and billing functions of the managed services environment 100. Regarding reporting, the reporting and billing module 118 enables managing of performance of delivery on a contract basis, enables managing financials on a contract basis, enables forecasting and planning and assists in managing third party service providers by providing metrics relating to third party service provider performance information, third party service provider financial information and contract compliance of the third party service provider. Regarding billing, the reporting and billing module 118 provides rating and invoicing support as well as accounts receivable and accounts payable management. With the rating support, the reporting and billing module 118 provides the ability to figure out what customer owes, such as per event or as part of a support service. With the invoicing support, the reporting and billing module 118 includes invoice generating and tracking functionality. With the accounts receivable support, the reporting and billing module 118 enables managing customer cost management and charge back accounting. With the accounts payable support, the reporting and billing module 118 enables the managed services environment to reconcile third party service provider actual invoices against expected third party service provider charges.

The managed deployment/installation function includes a site survey function, an end user survey portion, a scheduling and resource planning function, a data migration function, a software install and configuration script function, a progress tracking function and a requirements selection function. The site survey function automates transfer of site information between the managed deployment tool and the managed services platform. The site information includes a current state of customer and site specific requirements and network details by site. The end user survey portion integrates the capture of end user information including location and profile data with the managed services tools portion. The scheduling and resource planning function automatically generates project timelines, manages scheduling of product procurement and delivery with resource scheduling and enables customer self scheduling for deployments. The data migration function executes and track data migration based on contractually defined customer requirements. The software install and configuration script function maintains customer specific configuration scripts within the deployment tool portion; thus, the managed services system provides third party service providers with a standard set of configuration requirements and a stand set of steps to complete a configuration The progress tracking function monitors progress against statements of work, automatically notifies when at risk for missing a contractually agreed upon deployment date and generates status reports. The requirements selection function provides tools to assure that external software used within the managed services system functions properly with the managed services system.

The asset management function includes a configuration and planning function, an inventory planning function, a capacity and resource planning function, a service entitlement function, an automated asset update function, a billing function, a license management function, a usage metering function, a standards compliance function. The configuration and planning function plans imaging and configuration based on assets existing in the customer environment. The inventory planning function plans minimum and maximum inventory levels based on discovery of assets present in the customer environment. The capacity and resource planning function performs resource and capacity planning based on breadth and volume of discovered assets. High asset volumes may cause greater resource needs while lower volumes may limit resource needs. Scheduling is based on customer provided requirements such as via a statement of work. The service entitlement function enables a managed service help desk to have direct access to near current asset management for asset based service entitlement determinations. The automated asset update function provides an efficient service desk and dispatch services via access to asset information that is coupled to users. When a user contacts the managed services help desk and a case is opened for the user, the user's asset information is displayed. The billing function enables the managed services system to bill accurately based on current asset information. The automated asset discovery tool regularly updates the asset database may then be accessed to determine accurate rating and billing. The license management function assists customers with managing licenses by discovering the quantity of licenses in use and coupling usage to license availability. The usage metering function captures asset usage information; the asset usage information provides insight to both the managed service system and the customer on hardware and software inventory and requirements. The standards compliance function identifies non-compliant hardware and software by comparing captured hardware and software with customer standards.

The managed services methodology portion 104 includes a sales/solutioning module 140, a due diligence module 142, a site survey module 144, an asset discovery module 146, a deployment scheduling module 148, a system procurement module 150, a system installation and migration module 152 and a system disposal module 154.

The managed services tools portion 106 includes a plurality of tools relating to managed services. The managed deployment tools portion 106 provides two general functions: gathering data from a customer and providing an interface to a customer to allow the customer to schedule work or gather information. The managed deployment tools portion 106 provides the user interfaces via which users including customers and service providers access the

The managed services tools portion 106 includes a deployment scheduling tool module 160. The managed deployment tools portion 106 also includes vendor & tool evaluation guides module 162, a project estimating tool and guidelines module 164, a solution marketing tool module 166, a statement of work template module 168, a due diligence checklist module 170, a site survey checklist tool module 171, an asset discovery tool module 172, an imaging tool module 174, an application installation tool module 176, a settings/data migration tool module 186, and a data cleansing tool module 178. The deployment scheduling tool module 160 further includes an installation scheduling and communication tool module 180, a project timeline and resource management tool module 182 and a system procurement tool module 184 and a static reporting tool 188.

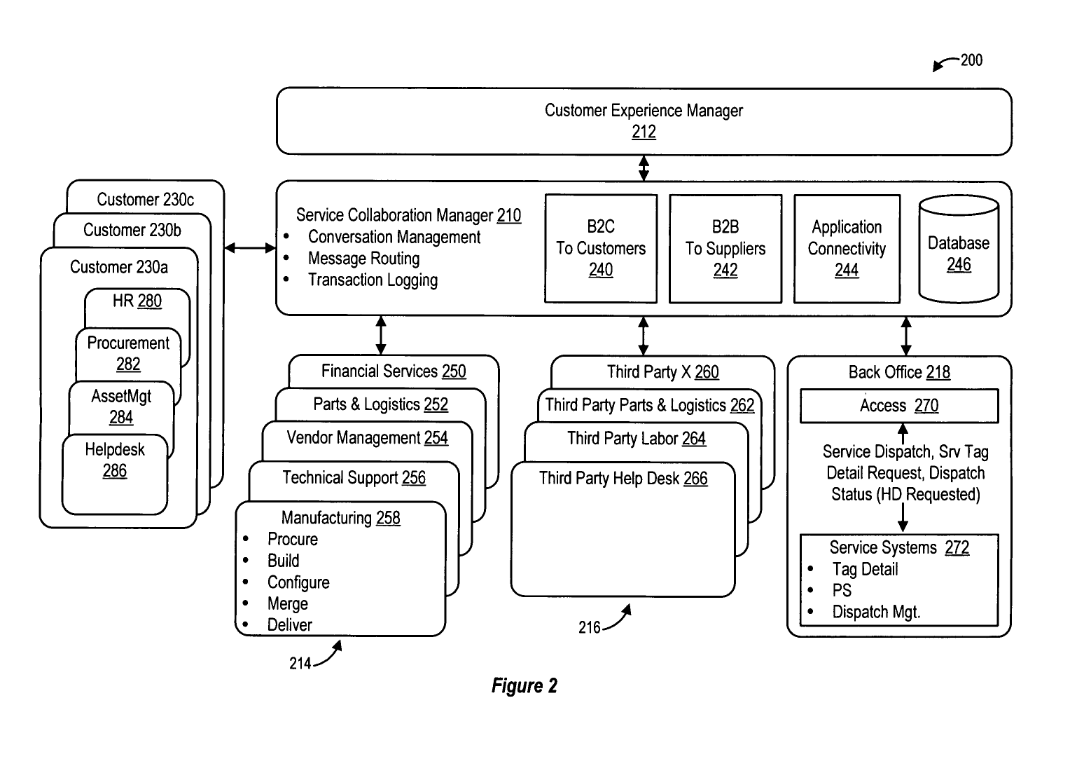

Referring to FIG. 2, a schematic block diagram of a system for managing services 100 within a managed services environment is shown. The system for managing services 100 enables the integration of planning manufacturing of systems into a managed services system.

The system for managing services 100 includes a service collaboration manager module 210, a customer experience manager module 212, a plurality of manufacturer module 214, a plurality of third party service supplier modules 216 and a back office module 218. Customers 230a, 230b, 230c interact with the system via the service collaboration manager module 210.

The service collaboration manager module 210 provides a conversation management function, a message routing function and a transaction logging function. The service collaboration manager module 210 includes a managed services provider to customer (B2C) module 240 a managed services provider to supplier (B2B) module 242, an application connectivity module 244 and a database module 246.

The plurality of managed services provider modules 214 include a financial services module 250, a parts & logistics module 252, a vendor management module 254, a technical support module 256 and a manufacturing module 258.

The plurality of third party service supplier modules 216 include a third party X module 260 (which represents any type of third party service), a third party parts & logistics module 262, a third party labor module 264 and a third party help desk module 266.

The back office module 218 performs a plurality of functions. More specifically, the back office module 218 enables tandem access between back office modules and the service collaboration manager module 210. The back office module provides a service dispatch function, an SRV tag detail request function as well as dispatch status function. The back office module 218 includes a tandem access module 270 a service systems module 272 and a user survey tool 273.

Each customer 230 may perform one or more a plurality of functions internally within the customer. For example, a customer may perform one or more of a human resources function 280, a procurement function 282, an asset management function 284 and a help desk function 286. Some customers may perform none of these functions internally and thus the managed service provider performs these functions for the customer.

Accordingly, the system for managing services 100 enables a managed service provider to minimize dependency on any given supplier. All customer interfaces are directly with the managed service provider, not the third party service suppliers. The managed service provider controls all customer information; this information includes data to enable adding or replacing suppliers, data for authorizing customer and supplier invoices and data to resolve invoice disputes. The manage service provider directly benefits from investments in technology development and intellectual capital. Additionally, the system for managing services 100 provides a scalable solution to enable the managed service supplier to plan for follow on business from a customer.

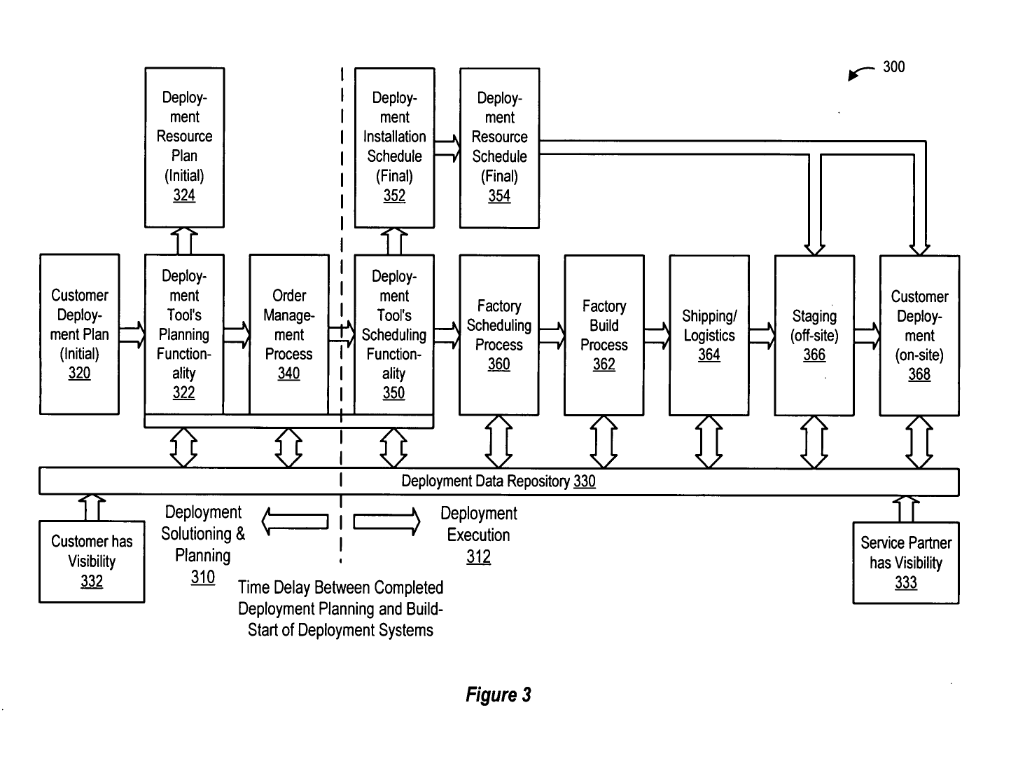

Referring to FIG. 3, a schematic block diagram of the operation of a managed services system 200 which incorporates supply chain integration is shown. More specifically, the operation of the managed services system is divided into a deployment solutioning and planning phase 310 and a deployment execution phase 312. There may be some time delay between a completed deployment solutioning and planning phase and the start of the deployment execution phase 312. One goal of the managed services system 200 which incorporates supply chain integration is to reduce this time delay.

During the deployment solutioning and planning phase 310, an initial customer deployment plan is developed at step 320. The deployment plan is developed using the deployment tool 106 at step 322. The deployment tools 106 interacts with a deployment resource plan 324 and stores information to a deployment data repository 330. By storing the deployment plan within the data repository 330, a customer has visibility into its deployment plan at step 332. Additionally, service partners may also have visibility into the deployment plan at step 333. The deployment tool 106 interacts with a factory order management process at step 340 to ensure that parts may be ordered and systems may be manufactured according to the deployment plan.

After the deployment plan is developed, the managed services system 200 proceeds to the deployment execution phase 312. During the deployment execution phase 312, the deployment tool 106 accesses scheduling functionality at step 350 to develop a final deployment installation schedule 352. The final deployment installation schedule is then used to develop a final deployment resource schedule at step 354.

The scheduling functionality also provides an input to a factory scheduling process at step 360. In one embodiment, because the managed services provider and the system manufacturer are linked, it is possible to synchronize the factory scheduling process of the system manufacturer with the needs of the managed services provider and thus with the needs of the managed services customer. The factory scheduling developed at step 360 is then used during the factory build at step 362. The factory build then provides the systems that conform to the deployment plan to a shipping and logistics module at step 362. The shipping and logistic module then provides the systems to a staging module at step 364. The staging module enables the systems to be staged prior to deployment at a customer site at step 366. The synchronized staging of systems within the deployment plan enables the managed services provider to control the delivery of systems to the managed services customer. One aspect of this control is preventing too large a quantity of systems from arriving at the managed services customer before the systems can actually be deployed by the managed services provider.

Throughout the deployment execution, the various modules interact with and store information to the deployment data repository 330. Accordingly, customers and service partners have visibility into the status of the deployment plan.

Accordingly, the managed services environment 100 integrates services delivery with the various value or supply chains such as hardware manufacturing and delivery, sale of third party software and peripherals and financial services (e.g., leasing). The managed services environment 100 provides greater value to a customer through the efficiencies, economies of scale, leveraged buying power, synchronization of order fulfillment (e.g., automatic coordination of a product order with scheduling of an installation service) consolidated reporting, and consolidated billing. Products provided to the managed services customer are viewed as a service within the managed services system (or conversely, services provided by the managed services provider may be viewed as a product by a system manufacturer). Such a managed services environment 100 optimizes resource utilization around proper skills match, optimizes scheduling with precise scheduling and reduced timelines, minimizes business disruption for a managed services customer and improves information based tracking and management of service events.

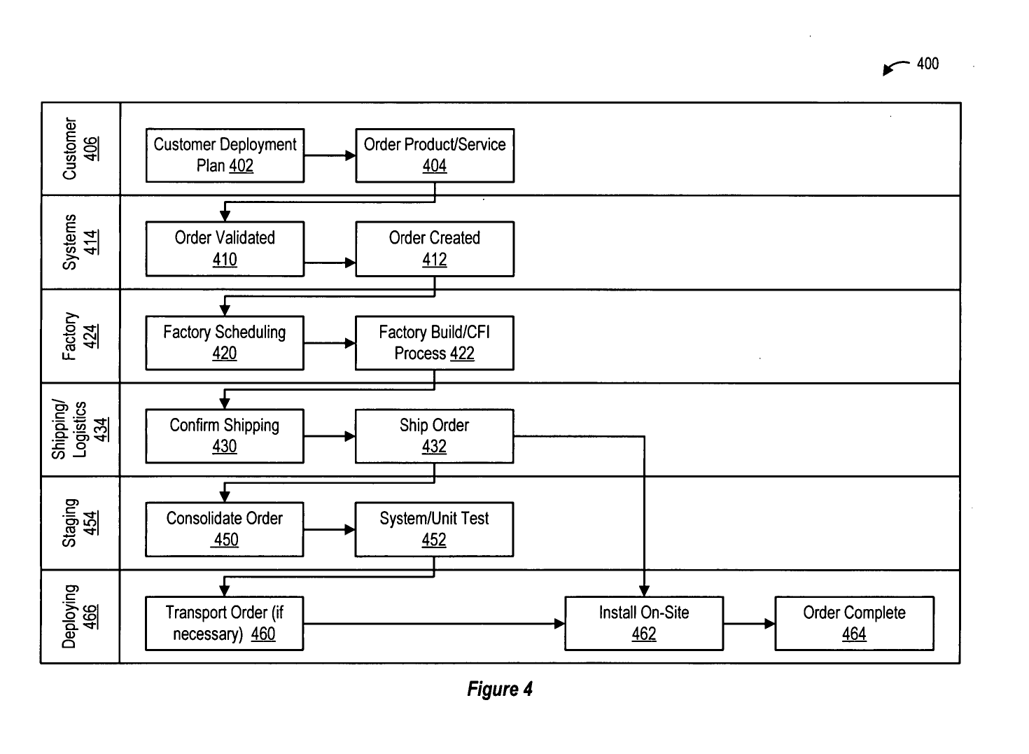

Referring to FIG. 4, a process map diagram of a high level order flow within the managed services environment 100 is shown. More specifically, a customer deployment plan 400 is used to order products and services 404 during a customer deployment portion 406 of the order flow of the managed services operation. The managed services environment 100 then validates orders 410 and creates orders 412 during a managed services system portion 414 of the order flow within the managed services operation. The managed services environment 100 then performs a factory scheduling function 420 and a factory build function 422 during a factory portion 424 of the order flow within the managed services operation. The managed services environment 100 then confirms a shipping schedule 430 and ships an order 432 during a shipping and logistics portion 434 of the order flow. The managed services environment 100 then consolidates an order 450 and performs system and unit tests 452 during a staging portion 454 of the order flow. The managed services environment 100 then transports the order 460 (if necessary), installs the order at the customer's site 462 and completes the order 464 during a deploying portion 466 of the order flow. Alternately, depending on the size of the order, staging may not be necessary and thus the order might be shipped 432 directly to the customer for installation.

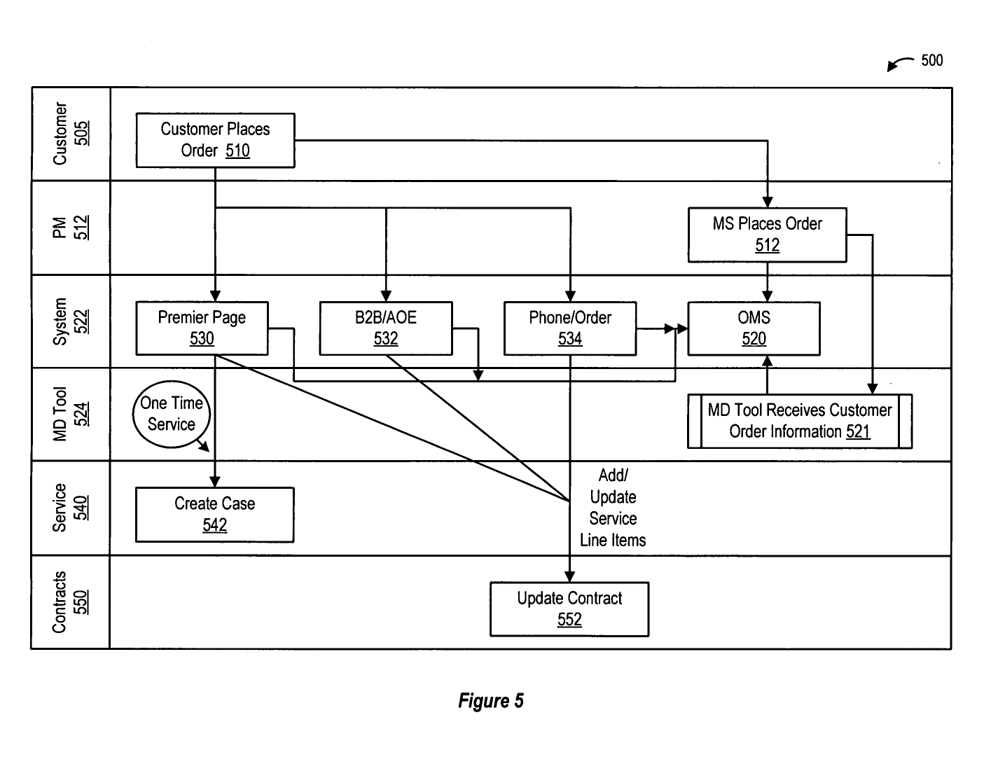

Referring to FIG. 5, a process map diagram of an ordering scenario 500 using a managed services environment is shown. More specifically, when a customer 505 places an order 510, the order may be placed via a plurality of different means. For example, the managed services customer may place the order via a customer specific program manager managed services module 512 which is located within the managed services environment 100. The customer specific program manager managed services module 512 in turn places the order with a system order management system 520 via a managed deployment tool 521. The order management system is located within a manufacturer order portion 522 and the managed deployment tool 521 is located within a managed deployment tool portion 524.

Alternately, the customer may place the order via a web site such as a premier customer page 530, via a manufacturer automated order entry module 532 or via a manufacturer telephone order process 534. In each instance, the order is then provided to the system order management system 520.

If the order is a one time service order, then the order proceeds to a service portion 540 where a case for the order is created 542. If the order is part of an on-going service contract, then the order is also forwarded to a contract portion 550 where contract information is updated to reflect the order 552.

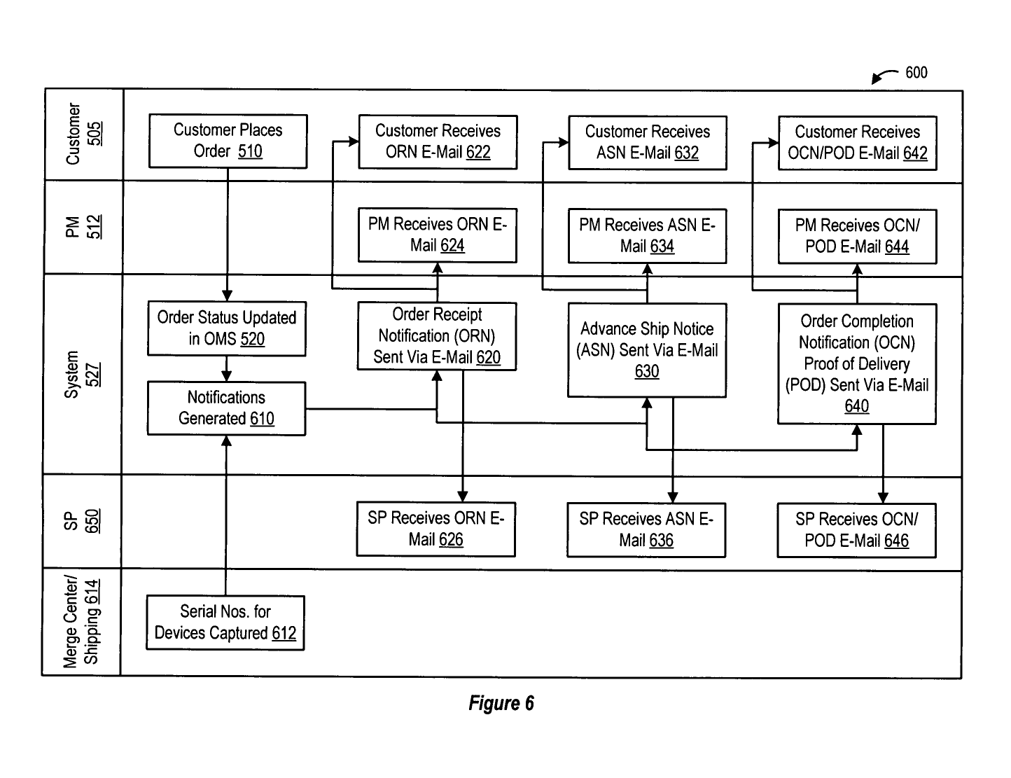

Referring to FIG. 6, a process map diagram of a notifications phase using a managed services environment is shown. The notifications phase represents a transfer of information between a managed services provider and a customer, a third party service provider and a managed services program manager. The notification scan include order receipt notifications (ORN), advance ship notifications (ASN) and order completion notifications (OCN) More specifically, when a customer places an order 510 and the order status is updated within the order management system 520, then various notifications are generated 610. During the generation of the notification, the serial numbers for the devices being ordered are captured 612 at a merge center shipping location 614 and stored within the managed services environment.

The notifications include an order receipt notification, an advance ship notification and an order completion notification which includes a proof of delivery. The order receipt notification is sent via email 620 so that the customer receives the order receipt notification 622, a program manager receives the order notification 624 and a third party service provider receives the order notification 626. The advance ship notification is sent via email 630 so that the customer receives the advance ship notification 632, a program manager receives the advance ship notification 634 and a third party service provider receives the advance ship notification 636. The order completion notification is sent via email 640 so that the customer receives the order completion notification 642, a program manager receives the order completion notification 644 and a third party service provider receives the order completion notification 646. The third party service provider is located within a service provider portion 650 of the managed services environment.

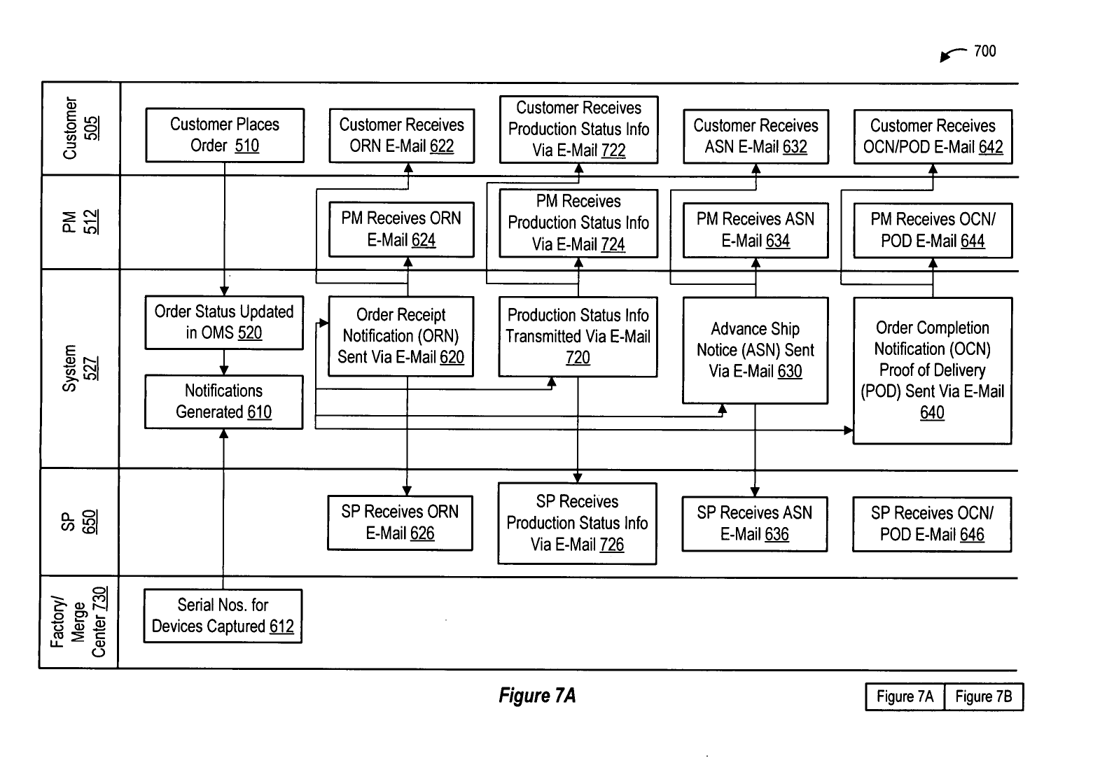

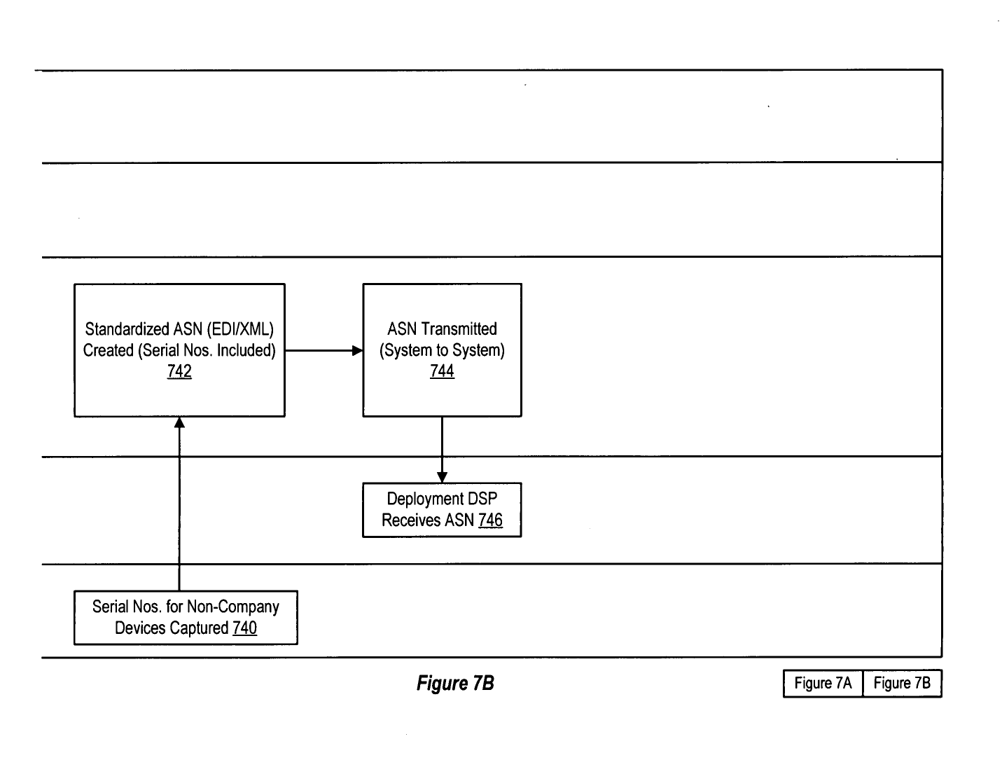

Referring to FIGS. 7A and 7B, a process map diagram of another notifications phase using a managed services environment is shown. This notifications phase 700 adds further features regarding notifications to the managed services environment 100. These features generally relate to production status information. By synchronizing the manufacturing of ordered systems with customer orders within the managed services environment 100, it is possible to provide production status information to the managed services customer.

More specifically, the notifications include a production status information notification 710. This production status information notification is sent via email 720 so that the customer receives the production status information notification via email 722, the program manager receives the production status information via email 724 and a third party service provider receives the production status information via email 726. Additionally, multiple production status information notifications can be provided at various points throughout the production process.

This notifications phase 700 also adds the ability to provide standardized advance ship notifications to customers regardless of where a particular product or system is manufactured. More specifically, the factory merge center 730 accesses and identifies serial numbers for non company devices 740. This information is then provided to the managed services system as a standardized advance ship notification 742 which may be provided from system to system at step 744. The system to system transmission is in a form that can be read by various systems and thus allows for the replacement of an email notification. (This system to system notification could be used to replace any of the email notifications.) The deployment service provider then receives the standardized advanced ship notification 746.

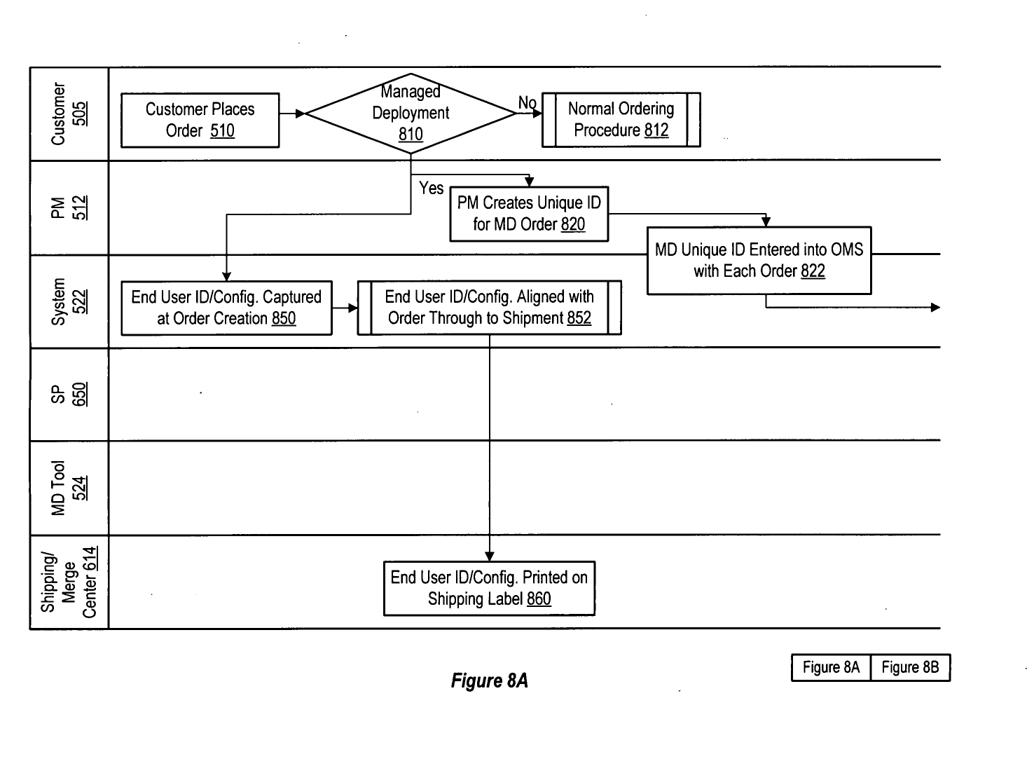

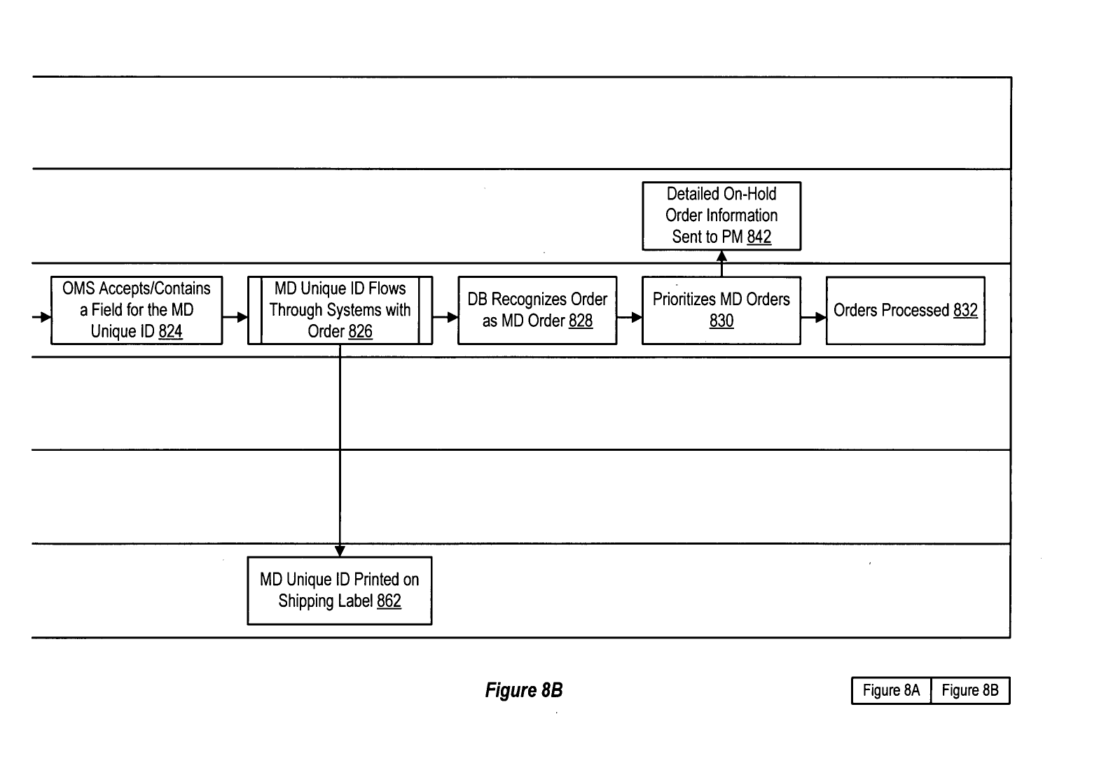

Referring to FIGS. 8A and 8B, a process map diagram of order identifiers using a managed services environment is shown. Order identifiers might include a customer end user identifier and a managed deployment order identifier. The customer end user identifier can server as a means to identify to whom or where each unit is to be placed. The customer end user identifier is captured with the order. By capturing this information when the order is placed, the customer end user identifier can be placed on a shipping label, packing slip or other form of identifier that is included with each shipped unit. Thus allows the service provider to more easily place of units within the customer when performing the deployment.

The managed deployment order identifier allows project managers to track all orders associated with a particular managed deployment project. The managed deployment order identifier flows through the factory and allows for the factory to identify a managed deployment order. The factory may also be able to recognize and prioritize managed deployment orders and to provide order status (i.e., orders that are on hold) to the appropriate project manager. The customer end user identifier and the managed deployment order identifier may be provided to the order management system.

More specifically, when a customer places an order 510, the order is review to determine whether the order is part of a managed deployment at step 810, if not then a normal ordering procedure is followed 812. If the order is part of a managed deployment, then the project manager creates a unique identifier for the managed deployment order at step 820. The managed deployment unique identifier is entered into the order management system for each order at step 822. The order management system accepts a field for the managed deployment unique identifier at step 824. The managed deployment unique identifier then flows through the manufacturing process for the system with the order at step 826. Because of the managed deployment unique identifier, the manufacturing database recognizes the order as part of a managed deployment order at step 828. The manufacturing system may then prioritize the order based upon the managed deployment status at step 830 and then the order is processed at step 840. Additionally, if any part of a managed deployment order is placed on hold, then detailed on hold order information is forwarded to the project manager at step 842.

Additionally, if the order is part of a managed deployment, an end user identifier is captured during order creation and stored within the managed services system at step 850. The end user identifier is then aligned with the order throughout the shipment process at step 852.

The end user identifier is printed on a shipping label for the unit at step 860. Additionally, the managed deployment unique identifier is printed on a shipping label at step 862.

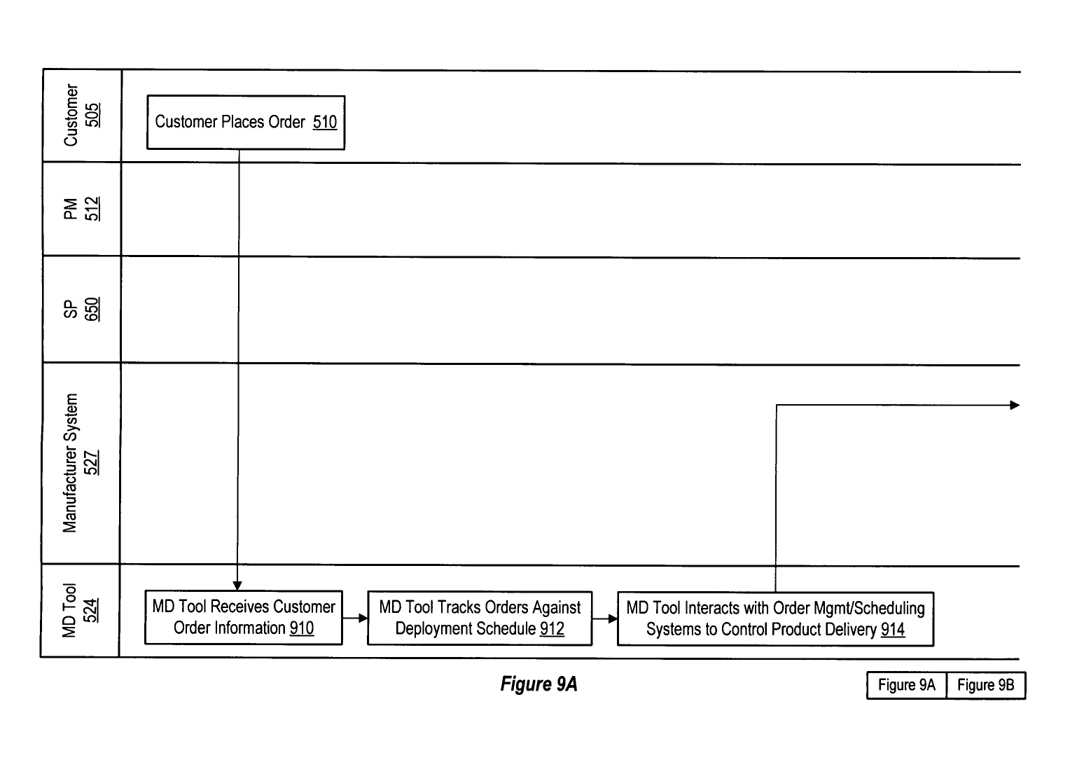

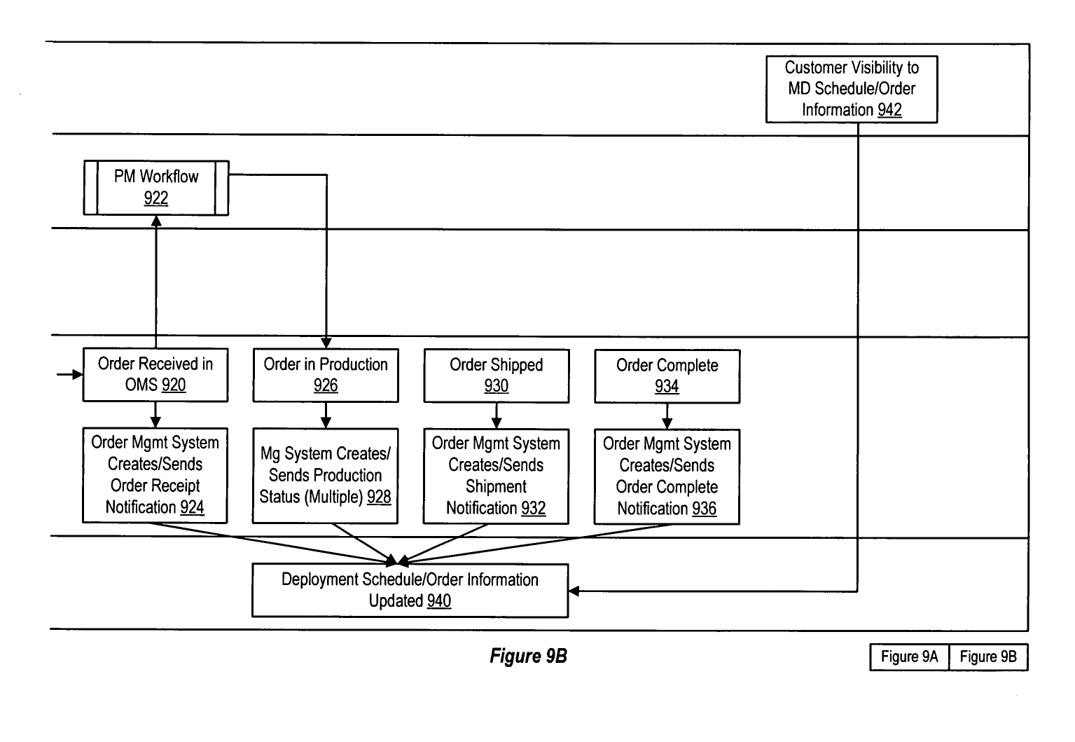

Referring to FIGS. 9A and 9B, a process map diagram of the operation of a deployment portion of a managed services environment is shown. The deployment portion of the managed services environment includes a direct flow of order information into a managed deployment tool as well as other order update information (e.g., order receipt, order completion, etc.) Accordingly, the managed deployment tool interacts with the order management and factory scheduling systems to allow the customer to have visibility into the managed deployment tool to, for example, allow the customer to determine deployment status. Thus, the managed deployment tool provides a central repository of order information that multiple parties (e.g., project manager, service provider, and customer) can access.

More specifically, when a customer places an order 510, the managed deployment tool receives the customer order information at step 910. The managed deployment tool then tracks orders against a predetermined deployment schedule at step 912. The managed deployment tool then interacts with order management and scheduling systems to control product delivery at step 914.

The order is then received by the manufacturer order management system at step 920. The order management system provides the order information to the project manager workflow at step 922. Additionally, the order management system creates and sends an order receipt notification at step 924. The order management system then places the order into production at step 926. The manufacturing system creates and sends production status information at step 928. (This production status information may be generated multiple times throughout the manufacturing process.) The order is then shipped at step 930. The order management system then creates and sends a shipment notification at step 932. The order is thus completed at step 934 and the order management system creates and sends an order complete notification at step 936.

As each notification is generated, the deployment schedule information stored within the managed deployment tool is updated at step 940. Additionally, the order information status information is updated within the managed deployment tool at step 940. Because this information is updated at each stage of the manufacturing process, the customer has visibility into the managed deployment schedule and order information at step 942.

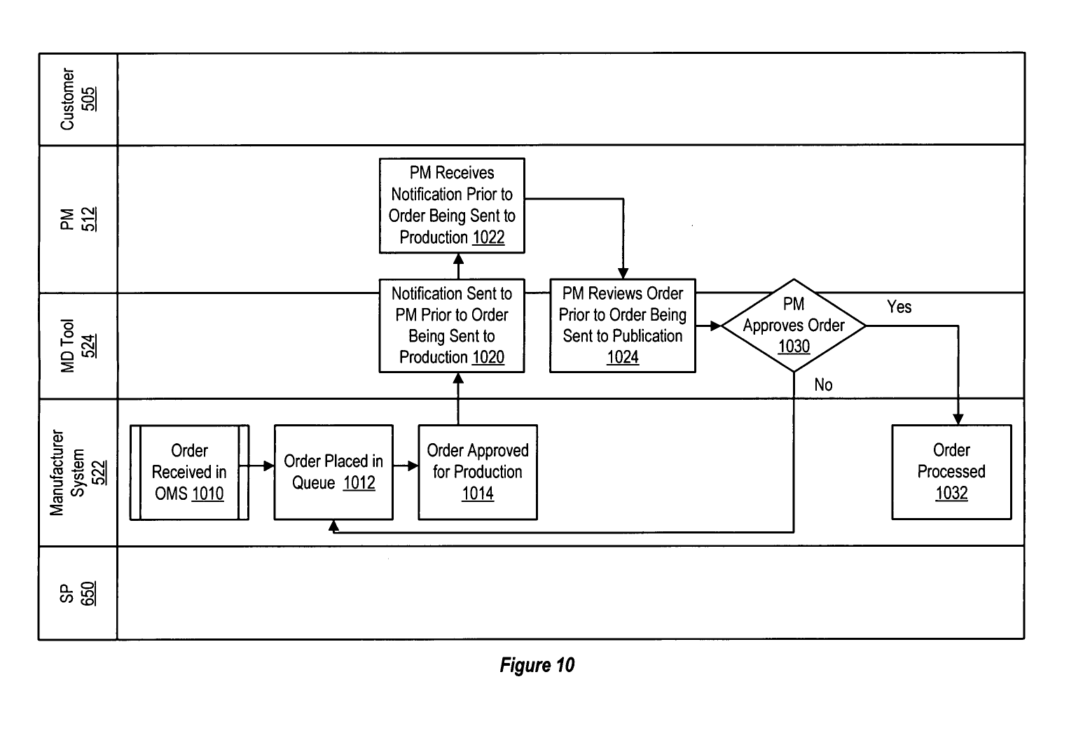

Referring to FIG. 10, a process map diagram of the operation of a project management workflow within a managed services environment is shown. The project management workflow provides the project manager with a notification and approval process for orders that are about to go into production. Accordingly, when the managed deployment tool interacts directly with an order management system and factory scheduling processes, the project manager still has input into the deployment process.

More specifically, when an order is received by the order management system at step 1010, the order is placed into a production queue at step 1012. When the order is approved for production at step 1014, then a notification is sent to the project manager prior to the order being sent to production at step 1020. Thus, the project manager receives the notification prior to the order being sent to production at step 1022. The project manager the reviews the order prior to the border being sent to publication (i.e., prior to the order being manufactured) at step 1024. If the project manager approves the order at step 1030, then the order is processed at step 1032. If the project manager does not approve the order, then the order is placed into the queue at step 1012.

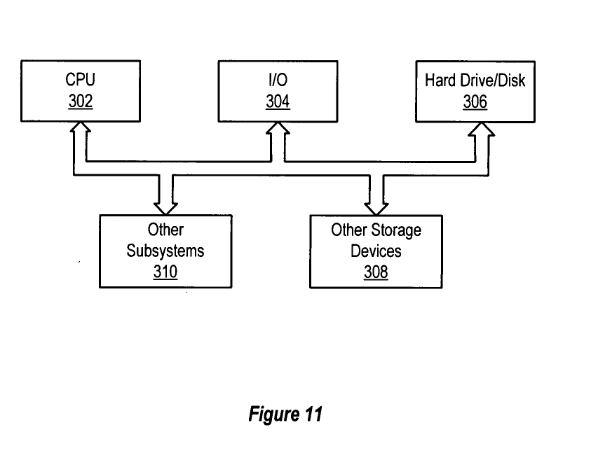

Referring to FIG. 11, a system block diagram of an information handling system 300 which is used within and serviced via a system for managing services 100 is shown. The information handling system 300 includes a processor 302, input/output (I/O) devices 304, such as a display, a keyboard, a mouse, and associated controllers, a non-volatile memory 306 such as a hard disk drive, and other storage devices 308, such as a floppy disk and drive and other memory devices, and various other subsystems 310, all interconnected via one or more buses 312.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

### OTHER EMBODIMENTS

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for providing managed services comprising:
synchronizing managed services product fulfillment with a manufacturer supply chain.

2. The method of claim 1 further comprising:
consolidating information relating the product fulfillment status within a managed services system.

3. The method of claim 1 further comprising:
optimizing resource scheduling based upon the synchronizing.

4. The method of claim 1 further comprising:
optimizing event synchronization based upon the synchronizing.

5. The method of claim 1 wherein:
the manufacturer supply chain includes at least one of a hardware manufacturing portion, a delivery portion, a third party software portion, a peripheral portion and a financial services portion.

6. The method of claim 1 wherein:
the synchronizing automatically coordinates a product order with scheduling of an installation service.

7. The method of claim 2 wherein:
products provided to a managed services customer are represented as services within the managed services system.

8. A method for providing managed services comprising:
synchronizing managed services product fulfillment with a manufacturer supply chain;
consolidating information relating the product fulfillment status within a managed services system; and,
optimizing production scheduling based upon the synchronizing.

9. The method of claim 8 wherein:
the manufacturer supply chain includes at least one of a hardware manufacturing portion, a delivery portion, a third party software portion, a peripheral portion and a financial services portion.

10. The method of claim 8 wherein:
the synchronizing automatically coordinates a product order with scheduling of an installation service.

11. The method of claim 8 wherein:
products provided to a managed services customer are represented as services within the managed services system.

12. An apparatus for providing managed services comprising:
means for synchronizing managed services product fulfillment with a manufacturer supply chain.

13. The apparatus of claim 12 further comprising:
means for consolidating information relating the product fulfillment status within a managed services system.

14. The apparatus of claim 12 further comprising:
means for optimizing resource scheduling based upon the synchronizing.

15. The apparatus of claim 12 further comprising:
means for optimizing event synchronization based upon the synchronizing.

16. The apparatus of claim 12 wherein:
the manufacturer supply chain includes at least one of a hardware manufacturing portion, a delivery portion, a third party software portion, a peripheral portion and a financial services portion.

17. The apparatus of claim 12 wherein:
the synchronizing automatically coordinates a product order with scheduling of an installation service.

18. The apparatus of claim 13 wherein:
products provided to a managed services customer are represented as services within the managed services system.

19. An apparatus for providing managed services comprising:
means for synchronizing managed services product fulfillment with a manufacturer supply chain;
means for consolidating information relating the product fulfillment status within a managed services system; and,
means for optimizing production scheduling based upon the synchronizing.

20. The apparatus of claim 19 wherein:
the manufacturer supply chain includes at least one of a hardware manufacturing portion, a delivery portion, a third party software portion, a peripheral portion and a financial services portion.

21. The apparatus of claim 19 wherein:
the synchronizing automatically coordinates a product order with scheduling of an installation service.

22. The apparatus of claim 19 wherein:
products provided to a managed services customer are represented as services within the managed services system.
